(19) United States
(12) Patent Application Publication
(10) Pub. No.: US 2008/0123663 A1
(43) Pub. Date: May 29, 2008

(54) METHOD AND APPARATUS FOR MANAGING TERNARY CONTENT ADDRESSABLE MEMORY ENTRIES FOR USE IN A DATA PACKET ROUTING DEVICE

(75) Inventor: Anand Kanagala, Edison, NJ (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: UTStarcom, Incorporated, Alameda, CA (US)

(21) Appl. No.: 11/564,728

(22) Filed: Nov. 29, 2006

(51) Int. Cl. H04L 12/56

(52) U.S. Cl. 370/395.32

(57) ABSTRACT

Managing TCAM entries within a TCAM matrix for use in a data packet routing device is disclosed. Additionally, a computer readable medium containing instructions to cause a processor to perform the method is also disclosed. One method comprises the steps of: (1) providing a plurality of information base agents for managing respective information bases, wherein the information bases include route data; (2) maintaining a list of TCAM entries that are available for assignment; (3) allocating blocks of available TCAM entries to each of the plurality of information base agents; (4) the plurality of information base agents storing route data into the TCAM entries of their respective blocks of TCAM entries; (5) determining that one information base agent of the plurality of information base agents needs additional TCAM entries; (6) providing additional TCAM entries to the one information base agent; and (7) updating the list of TCAM entries available for assignment.

### FIELD OF THE INVENTION

The present invention relates to a method and apparatus for TCAM route table management. The present invention is well-suited for use in a data packet forwarding device.

### BACKGROUND

Data packet routers receive, process, and forward data packets in a data communications network. The high volume of data traffic and the diversity of network protocols in modern data communications networks require data packet routers to process and forward data packets of different protocols very quickly. To process and forward data packets quickly, data packet routers must be able to perform very fast route data lookups of multiple network protocol specific route data to determine where to forward incoming data packets.

Data packet routers forward data packets based on forwarding data stored in a routing table such as a Classless Inter Domain Routing (CIDR) table, a Multi-Protocol Label Switching (MPLS) table, or other routing or forwarding tables of other similar network protocols.

CIDR is an Internet Protocol (IP) addressing scheme that provides for a floating boundary point between the network ID portion and the host ID portion of an IP address. In a CIDR table, Internet Protocol version 4 (IPv4) addresses are represented as a four-part dotted-decimal IP address, followed by a slash, then a number N from 0 to 32, such as A.B.C.D/N, where N is the CIDR prefix length. The first N bits of the 32 bit IP address comprise the CIDR prefix and correspond to the network ID field of the destination address of the incoming packet. The 32-N bits following the first N bits correspond to the host ID field of the destination address of the incoming packet. Data packet routers use CIDR prefixes to determine the best next-hop route based on the destination address in the incoming packet header. When performing a route data lookup, the longest CIDR prefix match reflects the best route to the destination. Thus, when performing a route data lookup in a CIDR table, the data packet router must be able to quickly determine which route datum has the longest CIDR prefix matching the lookup address. The data packet router then uses the forwarding data corresponding to the matching route data to determine where to send the data packet along its next hop through the network.

MPLS is a layer 2 network protocol whereby data packet routers within an MPLS domain add labels to data packets to facilitate fast switching of data packets through the MPLS domain. When an ingress data packet router receives an incoming data packet, it adds an MPLS header to the data packet and forwards the data packet to the next data packet router along the Label Switched Path (LSP). The labeled data packet is forwarded along the LSP by each intermediate data packet router by swapping labels until it reaches the end point of the LSP, at which point the egress data packet router removes the MPLS header and forwards the data packet based on, e.g., Layer 3 information such as an IP destination address, Layer 2 information address, or any underlying MPLS label. Each data packet router in the MPLS domain stores MPLS forwarding data and route data in an MPLS forwarding table. Thus, when performing a route data lookup in an MPLS table, the data packet router must be able to quickly determine which route datum matches the MPLS header of the incoming data packet. The data packet router then uses the forwarding data corresponding to the matching route data to determine where to send the data packet along its next hop along the LSP.

Ternary Content Addressable Memory (TCAM) is one known hardware solution that enables data packet routers to perform very fast route data lookups by using dedicated comparison circuitry to implement a route data lookup function in a single clock cycle. A TCAM compares binary input search data against a table of route data stored in the TCAM matrix and returns the TCAM address of the TCAM entry corresponding to the input search data. The data packet router then uses the output of the TCAM lookup to retrieve forwarding data from a specific location in a separate Random Access Memory (RAM) device. A TCAM is desirable for route data lookups in a CIDR table because each TCAM cell can store a binary 1, a binary 0, or a “don't care” value, where a “don't care” value can be stored in the least significant bits corresponding to the host ID portions of the CIDR addresses of the CIDR table.

When designing a data packet router, engineers typically do not know the network operator's network requirements particularly with respect to network traffic volume and interconnection complexity as a function of network protocol. To address this problem, engineers typically design routers to allow the network operator to allocate data packet router resources based on network requirements known at the time of initial deployment. However, as network requirements change over time, network operators are forced to either let the data packet router continue to operate with a non-optimal allocation of resources, which may cause network inefficiencies, or manually reallocate data packet router resources, resulting in network down time.

Thus, there exists a need for new methods and apparatus for intelligently and dynamically allocating data packet router resources, including TCAM based route data lookup sub-systems.

### SUMMARY OF THE INVENTION

A method and apparatus for managing TCAM entries within a TCAM matrix for use in a data packet routing device is disclosed. Additionally, a computer readable medium containing instructions to cause a processor to perform the method is also disclosed.

One preferred method of managing TCAM entries for use in a data packet routing device comprises the steps of: (1) providing a plurality of information base agents for managing respective information bases, wherein the information bases include route data; (2) maintaining a list of TCAM entries that are available for assignment; (3) allocating blocks of available TCAM entries to each of the plurality of information base agents; (4) the plurality of information base agents storing route data into the TCAM entries of their respective blocks of TCAM entries; (5) determining that one information base agent of the plurality of information base agents needs additional TCAM entries; (6) providing additional TCAM entries to the one information base agent; and (7) updating the list of TCAM entries available for assignment.

In a preferred embodiment, each of the respective information bases contains route data of a single network protocol, such as a Classless Inter Domain Routing (CIDR) table, a Multi-Protocol Label Switching (MPLS) forwarding table, an Asynchronous Transfer Mode (ATM) forwarding table, an Ethernet Media Access Control (MAC) address forwarding table, or other similar network protocol route data.

In a preferred embodiment, a block allocator performs the steps of maintaining a list of TCAM entries available for assignment and allocating blocks of available TCAM entries to each of the plurality of information base agents; an entry allocator performs the step of determining that one information base agent of the plurality of information base agents needs additional TCAM entries; and a block allocator performs the steps of providing additional TCAM entries to the one information base agent and updating the list of TCAM entries available for assignment. In one alternative embodiment each information base agent may have its own entry allocator, and further alternative embodiments may combine the functionality of the entry allocator and the information base agent.

The initial allocation of blocks of TCAM entries to each of the plurality of information base agents is preferably based on a forecasted quantity of required TCAM entries where the forecasted quantity of required TCAM entries may be derived from historical network statistics for each network protocol such as the maximum number of routes in the route data, an average number of routes, or a confidence threshold for the number of routes, the rate of change in the number of routes over time, the quantity of new routes added over time, the quantity of old routes deleted over time, or similar statistics, or any combination thereof. CIDR route data statistics may additionally include the number of routes of each prefix length, the rate of change in the number of routes of each prefix length over time, the quantity of new routes of each prefix length added over time, the quantity of old routes of each prefix length deleted over time, or similar statistics, or any combination thereof. Preferably, the CIDR allocator utilizes the network statistics to determine the allocation of TCAM resources with respect to the distribution of routes according to their prefix length. In an alternative embodiment, a network operator may define and manually configure an initial allocation of TCAM entries to each of the plurality of information base agents. The block allocator may also be configured to limit the total quantity of TCAM entries allocated to any one of the plurality of entry allocators to a predetermined maximum quantity. The predetermined maximum quantity of TCAM entries for each of the plurality of information base agents may be a default value, a value derived from historical network protocol statistics, a manually-configured user-defined value, or similar value, or any combination thereof. Configuring the block allocator to allocate no more than a predetermined maximum quantity of TCAM entries to any one of the plurality of entry allocators prevents any one of the plurality of information base agents from starving the rest of the plurality of information base agents of TCAM entries.

In a preferred embodiment, the step of information base agents storing route data into the TCAM entries includes prepending an extent identifier to each route datum where the extent identifier is used to manage multiple physically non-contiguous blocks of TCAM entries as a single logical block of TCAM entries. In an exemplary embodiment, the extent identifier may operate to identify an individual information base agent, multiple information base agents, an individual network protocol, multiple network protocols, a particular subset of an individual network protocol, an individual virtual router, a group of virtual routers, a packet type, a customer identifier, a type of service identifier, a class of service identifier, or other similar identifier, or any combination thereof.

In an embodiment where at least one of the plurality of information bases contains a CIDR table, the information base corresponding to the at least one of the plurality of information bases preferably contains a CIDR allocator that performs the step of determining that one information base agent of the plurality of information base agents needs additional TCAM entries. In this embodiment, a CIDR allocator also maintains the list of CIDR addresses according to CIDR prefix length, manages the blocks of TCAM entries allocated to its respective information base agent, determines that its respective information base agent requires additional TCAM entries, and requests additional TCAM entries. The CIDR allocator maintains the list of CIDR addresses according to CIDR prefix length by grouping together all CIDR route data having the same CIDR prefix length, arranging the groups of CIDR route data having the same CIDR prefix length in order of decreasing CIDR prefix length, and assigning each CIDR route datum to an individual TCAM entry such that no CIDR route datum having prefix length x is stored at a lower addressed TCAM entry than another CIDR route datum having prefix length>x, for all TCAM entries allocated to its corresponding information base agent. The CIDR allocator manages the blocks of TCAM entries allocated to its respective information base agent and determines that its respective information base agent requires additional TCAM entries by maintaining a record of which of its allocated TCAM entries are assigned to route data and which of its allocated TCAM entries are available for assignment. An alternative embodiment may combine the functionality of the CIDR allocator with the information base agent.

In a preferred embodiment, a block allocator, prior to the step of providing additional TCAM entries to an information base agent, performs the step of verifying that the information base agent needing additional TCAM entries will not exceed a predetermined maximum quantity of TCAM entries upon receipt of additional TCAM entries. The predetermined maximum quantity of TCAM entries for each of the plurality of information base agents may be a default value, a value derived from historical network protocol statistics, a manually-configured user-defined value, or similar value, or any combination thereof.

The disclosed apparatus for managing TCAM entries for use in a data packet routing device comprises: (1) a plurality of protocol agent means for storing route data into a TCAM and for managing a plurality of corresponding information bases, wherein each of the plurality of information bases includes route data; (2) a block allocator means for maintaining a list of TCAM entries that are available for assignment to each of the plurality of protocol agent means, and for allocating blocks of available TCAM entries to each of the plurality of protocol agent means; and (3) an entry allocator means for managing the blocks of TCAM entries allocated to the protocol agent means, and for determining that the protocol agent means needs additional TCAM entries.

In a preferred embodiment, each one of the plurality of information bases contains route data of a single network protocol such as a CIDR table, an MPLS forwarding table, an ATM forwarding table, an Ethernet bridging or forwarding table, or other similar network protocol. Preferably, at least one of the plurality of information bases contains a CIDR table.

In a preferred embodiment, each one of the plurality of protocol agent means includes an entry allocator means. An alternative embodiment may combine the functionality of the protocol agent means and the entry allocator means. In another alternative embodiment, the protocol agent means and the entry allocator means may be separate entities.

In the embodiment where at least one of the plurality of information bases contains a CIDR table, the protocol agent means: (1) maintains a list of CIDR addresses according to CIDR prefix length; (2) determines that it requires additional TCAM entries; and (3) requests additional TCAM entries from the block allocator means. The protocol agent means maintains a list of CIDR addresses according to CIDR prefix length by grouping together all CIDR route data having the same CIDR prefix length, arranging the groups of CIDR route data having the same CIDR prefix length in order of decreasing CIDR prefix length, and assigning each CIDR route datum to an individual TCAM entry such that no CIDR route datum having prefix length x is stored at a lower addressed TCAM entry than another CIDR route datum having prefix length>x, for all TCAM entries allocated to the protocol agent means. The protocol agent means determines that it requires additional TCAM entries by maintaining a record of which of its allocated TCAM entries are assigned to route data and which of its allocated TCAM entries are available for assignment. In addition, the CIDR allocator may utilize network statistics or network historical data to make an initial allocation of TCAM addresses with respect to the prefix length. That is, the CIDR allocator may have data related to how many routes of each particular prefix length it should anticipate, and place route entries in the TCAM accordingly, so as to lower the likelihood of having to move the entries.

In a preferred embodiment, the protocol agent means prepends an extent identifier to each route datum to facilitate the management of multiple physically non-contiguous blocks of TCAM entries as a single logical block of TCAM entries. In an exemplary embodiment, the extent identifier may operate to identify an individual information base agent, multiple information base agents, an individual network protocol, multiple network protocols, a particular subset of an individual network protocol, an individual virtual router, a group of virtual routers, a packet type, a customer identifier, a type of service identifier, a class of service identifier, or other similar identifier, or any combination thereof.

Finally, the disclosed computer readable medium contains instructions to cause a processor to perform the steps of: (1) providing a plurality of information base agents for managing respective information bases, wherein the information bases include route data; (2) maintaining a list of TCAM entries that are available for assignment; (3) allocating blocks of available TCAM entries to each of the plurality of information base agents; (4) the plurality of information base agents storing route data into the TCAM entries of their respective blocks of TCAM entries; (5) determining that an information base agent needs additional TCAM entries; (6) providing additional TCAM entries to an information base agent; and (7) updating the list of TCAM entries available for assignment.

By allowing for dynamic allocation of TCAM entries within a TCAM matrix, the present invention makes possible data packet routers that can perform very fast route data lookups for multiple network protocols while flexibly adapting to changing network requirements.

These as well as other aspects, advantages, and alternatives will become apparent to those of ordinary skill in the art by reading the following detailed description, with reference where appropriate to the accompanying drawings.

### BRIEF DESCRIPTION OF THE DRAWINGS

Exemplary embodiments of the present are described herein with reference to the drawings in which:

FIG. 1 is an illustration of one embodiment of the present invention, showing a relationship between logical entities performing the method for managing TCAM entries within the TCAM matrix.

FIG. 2 is a detailed illustration of the physical TCAM matrix and the information stored within TCAM entries of the TCAM matrix.

FIGS. 3A and 3B illustrate the concept of using extent identifiers to manage multiple physically non-contiguous keys as a single logical TCAM matrix.

FIG. 4 is an illustration of one embodiment of the present invention, showing a series of steps performed to manage TCAM entries for use in a data packet forwarding device.

### DETAILED DESCRIPTION OF THE DRAWINGS

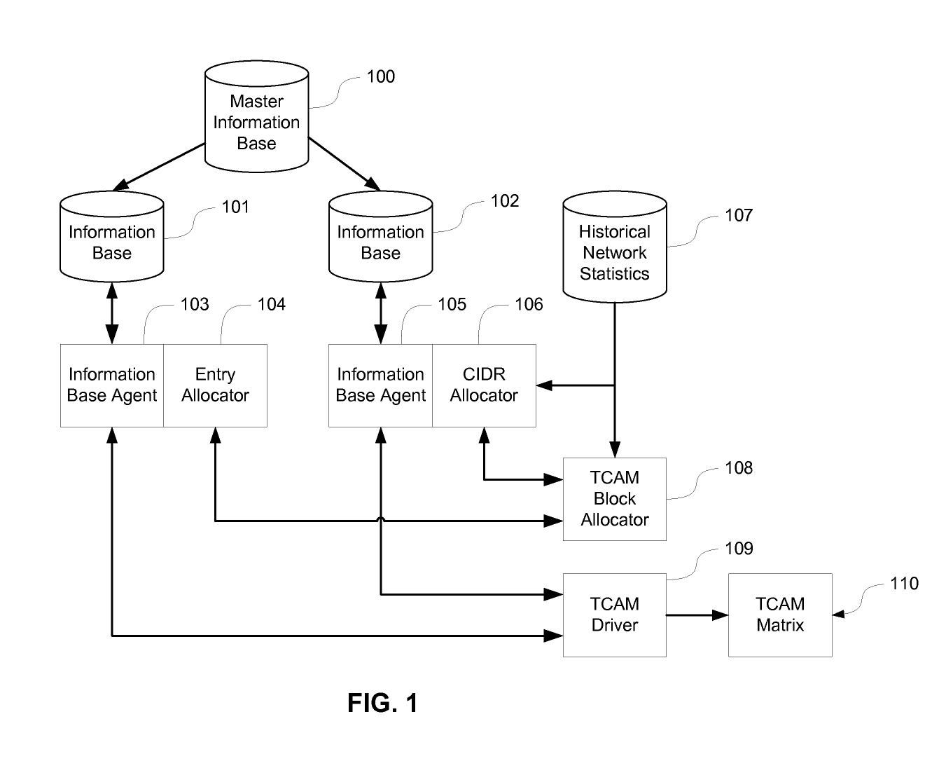

FIG. 1 illustrates a system for managing TCAM entries and keys for use in a data packet forwarding table, which may be part of a data packet router, data packet switch, or other similar network element. Master information base 100 contains route data and forwarding information corresponding to multiple network protocols supported by the data packet router, data packet switch, or other similar network element. Each one of the plurality of information bases 101, 102 contains a subset of the routing information contained in the master information base 100, where the subset of master information base 100 routing information contained within each one of the plurality of individual information bases 101, 102 may include the route data and forwarding data of a single network protocol such as a Classless Inter Domain Routing (CIDR) table, a Multi-Protocol Label Switching (MPLS) forwarding table, an Asynchronous Transfer Mode (ATM) forwarding table, an Ethernet Media Access Control (MAC) address forwarding table, or forwarding table of another similar network protocol. Each of the plurality of information bases 101, 102 have a corresponding information base agent 103, 105 that stores the route data of its corresponding information base 101, 102 into TCAM matrix 110 via TCAM driver 109.

Block allocator 108 assigns blocks of TCAM entries within TCAM matrix 110 to entry allocator 104 and to CIDR allocator 106. Block allocator 108 also maintains a list of TCAM entries within TCAM matrix 110 that are available for future assignment. In a preferred embodiment, the initial allocation of blocks of TCAM entries within TCAM matrix 110 to each of entry allocator 104 and CIDR allocator 106 is based on default values, or may be based on a forecasted quantity of TCAM entries required by information base agents 103 and 105, respectively. The forecasted quantity of required TCAM entries may be derived from historical network statistics 107. The historical network statistics for each protocol may include protocol-specific route data statistics such as the number of routes in the route data, the maximum number of routes previously stored, an average number of routes stored, or a confidence threshold for the number of routes. The confidence threshold may be a number (of routes) that has a predetermined probability of not being exceeded by a given information base agent.

Further alternatives may use the rate of change in the number of routes over time, the quantity of new routes added over time, the quantity of old routes deleted over time, or similar statistics, or any combination of the above. CIDR route data statistics may additionally include the number of routes of each prefix length, the rate of change in the number of routes of each prefix length over time, the quantity of new routes of each prefix length added over time, the quantity of old routes of each prefix length deleted over time, or similar statistics, or any combination thereof. Thus, the CIDR allocator may utilize the network statistics 107 or similar network data to make an initial allocation of TCAM addresses within the CIDR table with respect to the prefix length. The CIDR allocator uses the data related to how many routes of each particular prefix length it should anticipate, and place route entries in the TCAM accordingly, so as to lower the likelihood of having to move the CIDR table entries.

In an alternative embodiment, a network operator may define and manually configure an initial allocation of TCAM entries to entry allocator 104 and CIDR allocator 106.

Block allocator 108 may also be configured to limit the total quantity of TCAM entries allocated to entry allocator 104 or CIDR allocator 106 to a predetermined maximum quantity. Configuring block allocator 108 to allocate no more than a predetermined maximum quantity of TCAM entries to entry allocator 104 or CIDR allocator 106 prevents either of their corresponding information base agents 103, 105, respectively, from starving the other of TCAM entries. The predetermined maximum quantity of TCAM entries available to be allocated to each of either entry allocator 104 or CIDR allocator 106 may be a default value, a value derived from historical network protocol statistics, a manually-configured user-defined value, or similar value, or any combination thereof.

Information base 101 contains the route data of a network protocol other than a CIDR table such as an MPLS forwarding table, an ATM forwarding table, an Ethernet MAC address forwarding table, or similar routing table. Therefore, information base agent 103 corresponding to information base 101 has an entry allocator 104. Entry allocator 104 maintains a record of which blocks of TCAM entries have been assigned to its corresponding information base agent 103 by block allocator 108, determines in which individual TCAM entry of the blocks of TCAM entries assigned to its corresponding information base agent 103 to store each individual route datum, determines when its corresponding information base agent 103 requires additional blocks of TCAM entries, and requests additional blocks of TCAM entries from block allocator 108. In the preferred embodiment, entry allocator 104 is a separate software entity, but an alternative embodiment may combine the functionality of entry allocator 104 with information base agent 103.

Information base agent 105 contains a CIDR table, and thus, its corresponding information base agent 105 has a CIDR allocator 106. CIDR allocator 106 maintains a strict ordering of the CIDR route data of its corresponding information base agent 105 by grouping together all CIDR route data having the same CIDR prefix length, arranging the groups of CIDR route data having the same CIDR prefix length in order of decreasing CIDR prefix length, and assigning each CIDR route datum to an individual TCAM entry such that no CIDR route datum having prefix length x is stored a lower addressed TCAM entry than another CIDR route datum having prefix length>x, for all TCAM entries allocated to its corresponding information base agent 105. CIDR allocator 106 also maintains a record of which blocks of TCAM entries have been assigned to its corresponding information base agent 105 by block allocator 108, determines when its respective information base agent 105 requires additional TCAM entries, and requests additional TCAM entries from block allocator 108. In the preferred embodiment, CIDR allocator 106 is a separate software entity, but an alternative embodiment may combine the functionality of CIDR allocator 106 with information base agent 105.

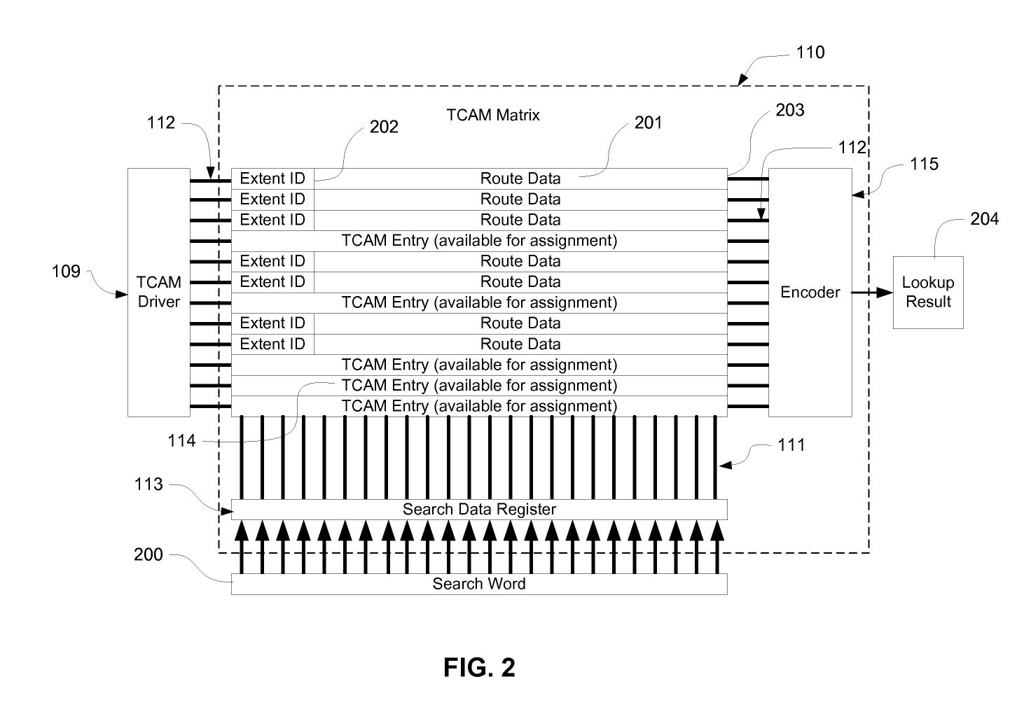

FIG. 2 shows a more detailed illustration of TCAM matrix 110. A key 203 comprised of a route datum 201 and an extent ID 202 is stored in an individual TCAM entry. The key 203 is a unique binary string that TCAM matrix 110 will compare against a search word 200 during a route data lookup. Each one of the plurality of information base agents 103, 105 maintains a record that relates each route datum 201 to its corresponding key 203 and its corresponding TCAM entry such that each of the plurality of information base agents 103, 105 knows where each route datum of its corresponding information base 101, 102 is stored within TCAM matrix 110.

When performing a route data lookup in TCAM matrix 110, search word 200 is first loaded into search data register 113. Search word 200 is then broadcast from search data register 113 along TCAM searchlines 111 that run vertically in FIG. 2 through each TCAM cell within TCAM matrix 110. For example, searchline Z broadcasts the value of bit Z in search data register 113 to column Z in TCAM matrix 110 such that bit Z of search word 200 can be compared to bit Z of every key loaded into TCAM matrix 110. TCAM matchlines 112 run horizontally across TCAM matrix 110. At the start of each search process, the TCAM sets all TCAM matchlines 112 to logical high. Each TCAM cell in a key of TCAM matrix 110 compares its stored value with the value broadcast on its corresponding searchline 111. If the values match, then that TCAM cell leaves matchline 112 at logical high, but if the values do not match, then that TCAM cell will reset matchline 112 to logical low. If all TCAM cells in a key of TCAM matrix 110 match the values broadcasted on each of their corresponding TCAM searchlines 111, then the TCAM matchline 112 corresponding to the matching key will remain at logical high, indicating a matching lookup. Conversely, if any TCAM cell in a key determines that its stored value does not match the value broadcast on its corresponding TCAM searchline 111, then the matchline 112 will be at logical low, indicating a mismatch. In the case where “don't care” values cause multiple matches, encoder 115 contains logic that determines and outputs lookup result 204 corresponding to the best of the multiple key matches. Typically, the match with the lowest address is provided.

The strict ordering of CIDR route data managed by CIDR allocator 106 enables encoder 115 to return a lookup result 204 corresponding to the TCAM address of the key containing the CIDR route datum corresponding to the longest CIDR prefix matching the search word 200 in search data register 113. The CIDR route datum corresponding to the longest CIDR prefix matching the search word 200 in search data register 113 is the most specific (i.e. the best) route for the case where multiple keys match the search word 200 in search data register 113.

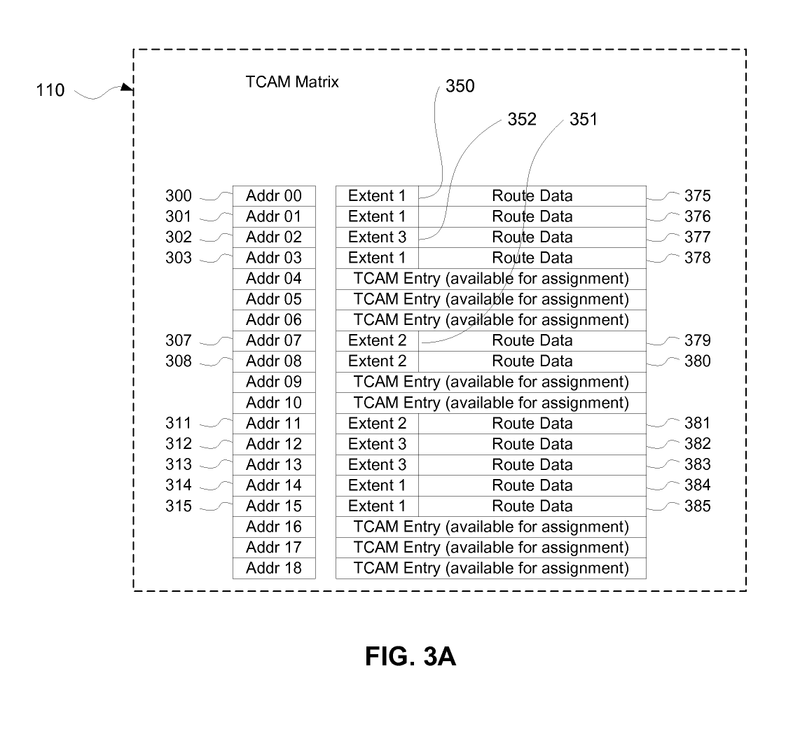

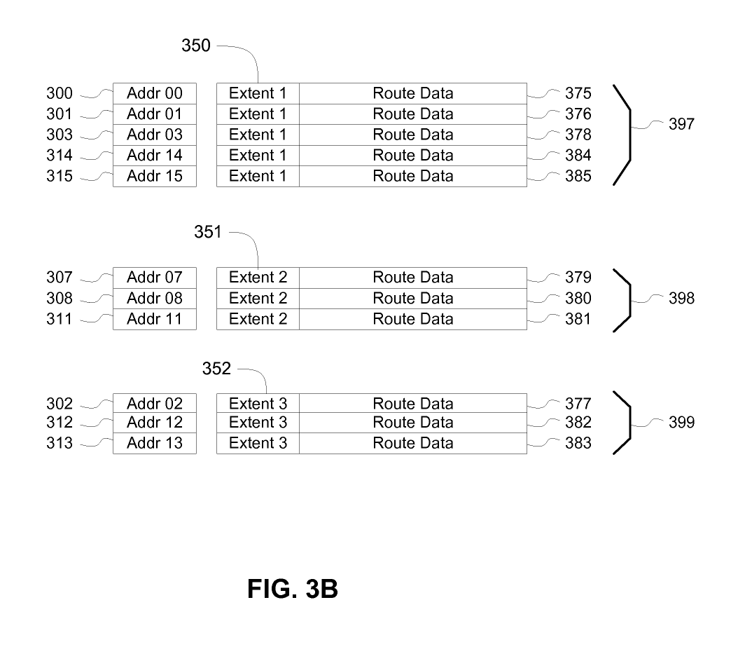

FIGS. 3A and 3B show an illustration of using multiple extent identifiers 350-352 to manage multiple pluralities of keys 375-385 stored at physically non-contiguous TCAM addresses within a single physical TCAM matrix 110 as multiple logical TCAM matrices 397-399 containing blocks of logically contiguous TCAM addresses. In particular: keys 375, 376, 378, 384, and 385 located at physically non-contiguous TCAM addresses 300, 301, 303, 314, and 315, respectively, correspond to extent identifier 350; keys 379, 380, and 381 located at physically non-contiguous TCAM addresses 307, 308, and 311, respectively, correspond to extent identifier 351; and keys 377, 382, and 383 stored at physically non-contiguous TCAM addresses 302, 312, and 313 correspond to extent identifier 352. Each extent identifier enables its corresponding keys to be managed as a single logical TCAM matrix even though its corresponding keys may be located at physically non-contiguous TCAM addresses within TCAM matrix 110. In an exemplary embodiment, each of the plurality of extent identifiers 350, 351, 352 may operate to identify one of the plurality of individual information base agents 103, 105, multiple information base agents, an individual network protocol, multiple network protocols, a particular subset of an individual network protocol, an individual virtual router, a group of virtual routers, a packet type, a customer identifier, a type of service identifier, a class of service identifier, or other similar identifier, or any combination thereof.

Note also that for purposes of illustration, the examples of FIGS. 3A and 3B depict blocks of TCAM addresses as small as one entry. Of course, blocks of entries may be any size such as 10, 100, 1000, or more, entries, and are preferably larger than a single entry.

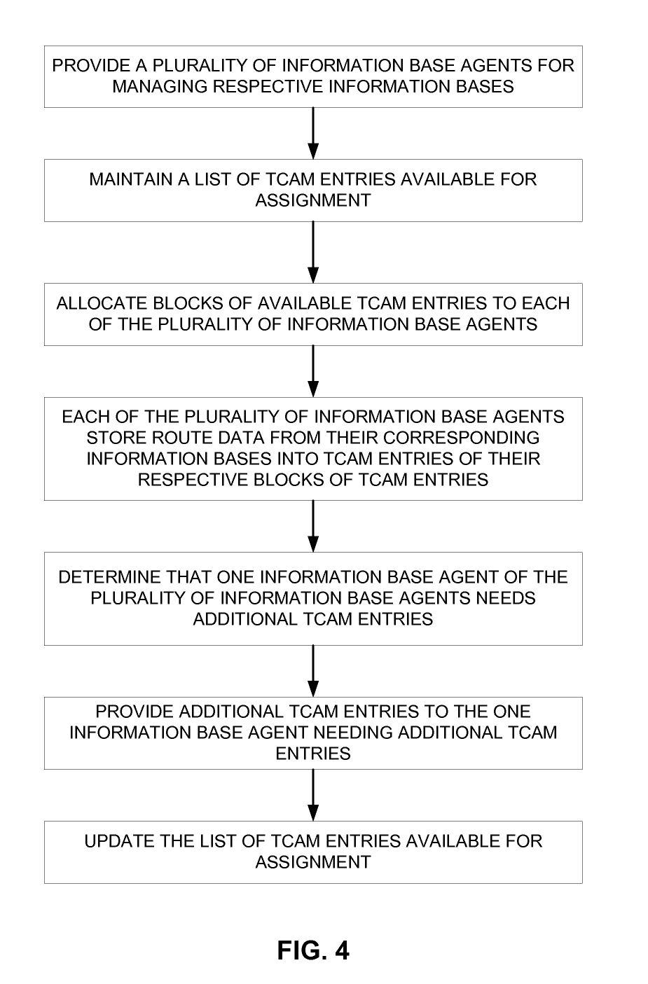

FIG. 4 illustrates a process for managing TCAM entries and keys for use in a data packet forwarding table, which may be part of a data packet router, data packet switch, or other similar network element. The process comprises the steps of: providing a plurality of information base agents for managing respective information bases; maintaining a list of TCAM entries available for assignment; allocating blocks of available TCAM entries to each of the plurality of information base agents; each of the plurality of information base agents storing route data of their corresponding information bases into TCAM entries of their respective blocks of TCAM entries; determining that one information base agent of the plurality of information base agents needs additional TCAM entries; providing additional TCAM entries to the one information base agent needing additional TCAM entries; and updating the list of TCAM entries available for assignment.

In a preferred embodiment, a block allocator performs the step of maintaining a list of TCAM entries available for assignment, and allocating blocks of available TCAM entries to each of the plurality of information base agents. An entry allocator performs the step of determining that one information base agent of the plurality of information base agents needs additional TCAM entries. Then, a block allocator performs the steps of providing additional TCAM entries to the one information base agent needing additional TCAM entries, and updating the list of TCAM entries available for assignment.

Exemplary embodiments of the invention have been described above. Those skilled in the art will appreciate that changes may be made to the embodiments described without departing from the true spirit and scope of the invention as defined by the claims.

We claim:

1. A method of managing TCAM entries for use in a data packet routing device, comprising:
providing a plurality of information base agents for managing respective information bases, wherein the information bases include route data;
maintaining a list of TCAM entries that are available for assignment;
allocating blocks of available TCAM entries to each of the plurality of information base agents;
the plurality of information base agents storing route data into the TCAM entries of their respective blocks of TCAM entries;
determining that one information base agent of the plurality of information base agents needs additional TCAM entries;
providing additional TCAM entries to the one information base agent; and
updating the list of TCAM entries available for assignment.

2. The method of claim 1 wherein the step of allocating blocks of available TCAM entries to each of the plurality of information base agents comprises making an initial allocation based on a forecasted quantity of required TCAM entries.

3. The method of claim 2 wherein the forecasted quantity of required TCAM entries is derived from historical network statistics.

4. The method of claim 1 wherein the step of information base agents storing route data into the TCAM entries includes prepending an extent identifier to each route datum.

5. The method of claim 4 wherein the extent identifier is used to manage multiple physically non-contiguous blocks of TCAM entries as a single logical block of TCAM entries.

6. The method of claim 4 wherein the extent identifier includes a protocol identifier.

7. The method of claim 4 wherein the extent identifier comprises a protocol identifier and a virtual router identifier.

8. The method of claim 1 wherein each of the respective information bases contains route data of a single network protocol.

9. The method of claim 1 wherein the route data of at least one of the plurality of information bases is a list of CIDR addresses.

10. The method of claim 9 wherein the at least one of the plurality of information base agents includes a CIDR allocator.

11. The method of claim 10 wherein the CIDR allocator maintains the list of CIDR addresses according to CIDR prefix length, manages the blocks of TCAM entries allocated to its respective information base agent, determines that its respective information base agent requires additional TCAM entries, and requests additional TCAM entries.

12. The method of claim 1 further comprising;
prior to the step of providing additional TCAM entries to an information base agent, verifying that the information base agent needing additional TCAM entries will not exceed a predetermined maximum quantity of TCAM entries upon receipt of additional TCAM entries.

13. A method of managing TCAM entries for use in a data packet routing device, comprising:
providing a plurality of information base agents for managing respective information bases, wherein the information bases include route data;
providing a block allocator, wherein the block allocator maintains a list of TCAM entries that are available for assignment and allocates blocks of available TCAM entries to each of the plurality of information base agents;
the plurality of information base agents storing route data into the TCAM entries of their respective blocks of TCAM entries;
providing an entry allocator for each of the plurality of information base agents, wherein the entry allocator manages the blocks of TCAM entries allocated to its respective information base agent, determines that its respective information base agent requires additional TCAM entries, and requests additional TCAM entries from the block allocator; and
a block allocator providing additional TCAM entries to the entry allocators and updating the list of TCAM entries available for assignment.

14. The method of claim 13 wherein the step of allocating blocks of available TCAM entries to each of the plurality of information base agents comprises making an initial allocation based on a forecasted quantity of required TCAM entries.

15. The method of claim 13 wherein the forecasted quantity of required TCAM entries is derived from historical network statistics.

16. The method of claim 13 wherein the step of information base agents storing route data into the TCAM entries includes prepending an extent identifier to each route datum to facilitate the management of multiple physically non-contiguous blocks of TCAM entries as a single logical block of TCAM entries.

17. The method of claim 16 wherein the extent identifier includes a protocol identifier.

18. The method of claim 16 wherein the extent identifier comprises a virtual router identifier and a protocol identifier.

19. The method of claim 13 wherein each of the respective information bases contains route data of a single network protocol.

20. The method of claim 13 wherein the route data of at least one of the plurality of information bases is a list of CIDR addresses.

21. The method of claim 19 wherein the entry allocator is a CIDR allocator that maintains the CIDR list according to CIDR prefix length, manages the blocks of TCAM entries allocated to its respective information base agent, determines that its respective information base agent requires additional TCAM entries, and requests additional TCAM entries from the block allocator.

22. The method of claim 13 wherein, prior to the step of providing additional TCAM entries to a requesting entry allocator, verifying that the information base agent corresponding to the requesting entry allocator will not exceed a predetermined maximum quantity of TCAM entries upon receipt of additional TCAM entries.

23. An apparatus for managing TCAM entries for use in a data packet routing device, comprising:
a plurality of protocol agent means for storing route data into a TCAM and for managing a plurality of corresponding information bases, wherein each of the plurality of information bases includes route data;
a block allocator means for maintaining a list of TCAM entries that are available for assignment to each of the plurality of protocol agent means, and for allocating blocks of available TCAM entries to each of the plurality of protocol agent means; and
wherein each of the plurality of protocol agent means includes an entry allocator means for managing the blocks of TCAM entries allocated to its corresponding protocol agent means, and for determining that its corresponding protocol agent means needs additional TCAM entries.

24. The apparatus of claim 23, wherein each of the plurality of protocol agent means prepends an extent identifier to each route datum to facilitate the management of multiple physically non-contiguous blocks of TCAM entries as a single logical block of TCAM entries.

25. The apparatus of claim 23, wherein each of the plurality of protocol agent means maintains a list of CIDR addresses according to CIDR prefix length; determines that it requires additional TCAM entries; and requests additional TCAM entries from the block allocator means.

26. Computer readable medium having stored therein instructions to cause a processor to execute the steps of:
providing a plurality of information base agents for managing respective information bases, wherein the information bases include route data;
maintaining a list of TCAM entries that are available for assignment;
allocating blocks of available TCAM entries to each of the plurality of information base agents;
the plurality of information base agents storing route data into the TCAM entries of their respective blocks of TCAM entries;
determining that an information base agent needs additional TCAM entries;
providing additional TCAM entries to an information base agent; and
updating the list of TCAM entries available for assignment.
